(19) United States
(12) Patent Application Publication
(10) Pub. No.: US 2012/0189894 A1
(43) Pub. Date: Jul. 26, 2012

(54) ELECTRODE ASSEMBLY AND SECONDARY BATTERY INCLUDING THE SAME

(75) Inventor: Changbum AHN, Yongin-si (KR)

(73) Assignee: SAMSUNG SDI CO., LTD., Yongin-si (KR)

(21) Appl. No.: 13/357,898

(22) Filed: Jan. 25, 2012

Related U.S. Application Data
(60) Provisional application No. 61/436,361, filed on Jan. 26, 2011.

(51) Int. Cl. H01M 2/18; H01M 10/05; H01M 4/30; H01M 2/16

(52) U.S. Cl. 429/135; 429/139; 29/623.1; 29/623.4

(57) ABSTRACT

An electrode assembly for a secondary battery that includes pressing parts are formed on separators surrounding positive and negative electrodes so that the electrode assembly can be bent in a zigzag shape to form a stacked structure, and thus the thermal stability of the electrode assembly can be improved and the stacked structure of the electrode assembly can be easily formed. In addition, electrolyte can easily permeate the electrode assembly. The electrode assembly includes separators, positive and negative electrode plates disposed between the separators, and pressing parts formed on the separators between the positive and negative electrode plates. Guide parts are formed at the pressing parts, and the separators are bent at the guide parts.

### CLAIM OF PRIORITY

This application claims priority to and the benefit of Provisional Application No. 61/436,361, filed on 26 Jan. 2011, in the United States Patent and Trademark Office, the entire content of which is incorporated herein by reference.

### BACKGROUND THE INVENTION

1. Field of the Invention

The present invention generally relates to an electrode assembly and a secondary battery including the electrode assembly.

2. Description of the Related Art

The demand for secondary batteries as energy sources has been largely increased with the development and wide-use of mobile devices. Among secondary batteries, lithium secondary batteries have been commercialized and widely used owing to their high energy densities, high operating voltages, long life cycles, and low self-discharge rates.

According to electrodes and electrolyte, lithium secondary batteries can be classified into lithium-ion batteries, lithium-ion polymer batteries, lithium polymer batteries, etc. Since lithium-ion polymer batteries have less electrolyte leakage and relatively low weights and can be easily manufactured into various shapes with lower costs, the use of lithium-ion polymer batteries is increased.

A second battery includes an electrode assembly configured by a positive electrode, a separator, and a negative electrode. According to the structure of the positive electrode, the separator, and the negative electrode, the electrode assembly can be classified into a jelly-roll (winding) type and a stack type. Jell-roll type electrode assemblies are manufactured as follows: metal foil used as electrode collectors is coated with materials such as an electrode active material and is dried and pressed; the metal foil is cut into bands having a predetermined width and length; and the bands are spirally wound after disposing a separator between the bands to separate the bands as positive and negative electrodes. Although jelly-roll type electrode assemblies are suitable for cylinder type batteries, they are unsuitable for prism type batteries or pouch type batteries due to limitations such as stripping of an electrode active material and low space efficiency. On the other hand, stack type electrode assemblies can be easily formed into a prismatic shape because stack type electrode assemblies are formed by sequentially stacking positive and negative electrodes. However, stack type electrode assemblies are manufactured through relatively complex processes, and if they received an impact or blow, they can be short-circuited due to slipping of electrodes.

The above information disclosed in this Related Art section is only for enhancement of understanding of the background of the invention and therefore it may contain information that does not form the prior art that is already known to a person of ordinary skill in the art.

### SUMMARY OF THE INVENTION

An aspect of the present invention provides for an electrode assembly and a secondary battery including the electrode assembly. In the electrode assembly, pressing parts are formed on separators surrounding positive and negative electrodes so that the electrode assembly can be bent in a zigzag shape to form a stacked structure, and thus the thermal stability of the electrode assembly can be improved and the stacked structure of the electrode assembly can be easily formed.

Another aspect of the present invention provides an electrode assembly into which electrolyte can easily permeate, and a secondary battery including the electrode assembly.

According to an exemplary embodiment of the present invention, a secondary battery having an electrode assembly, may include a plurality of positive and negative electrode plates. This exemplary embodiment further includes a first separator in which each positive and negative electrode plate of the plurality of positive and negative electrode plates are disposed on the first separator in a side-by-side manner with alternating positive and negative electrode plates and the first separator is folded at a guide part in a zigzag fashion. The guide part may be disposed in the first separator and between the positive and negative electrode plates.

Another aspect of the present invention provides for the secondary battery to include a pressing part of a predetermined width between each alternating positive and negative electrode plate sealing the first separator, and separating each alternating positive and negative electrode plate from each other.

Another aspect of the present invention may have the secondary battery include a second separator disposed on an opposite side of the plurality of positive and negative electrode plates to that of the first separator and on each positive and negative electrode plate of the plurality of positive and negative electrode plates.

Another aspect of the present invention may have the guide part include a plurality of holes though at least one of the first and second separator.

Another aspect of the present invention may have the guide part be formed in the pressing part.

Another aspect of the present invention may have the secondary include a positive tab extending from each of the plurality of positive electrode plates and further include a negative tab extending from each of the plurality of negative electrode plates.

Another aspect of the present invention may have the secondary battery further include a pouch to hold the electrode assembly and electrolyte.

Another aspect of the present invention may have the secondary battery include a second and third separators, the plurality of positive electrode plates may be disposed on the first separator, said second separator is disposed on a side of the plurality of positive electrode plates opposite to that of the first separator. The secondary battery may further include a plurality of negative electrode plates disposed on the second separator on an opposite side from that of the plurality of positive electrode plates and, and said third separator may be disposed on the plurality of negative electrode plates on an opposite side from that of the plurality of positive electrode plates.

Another aspect of the present invention may have the secondary battery further include a guide part is disposed through at least one of the first, with second and third separator between the positive and negative electrode plates.

Another aspect of the present invention may have the secondary battery further include a spacing between each positive electrode plate greater than a width of a single positive or negative electrode plate, the plurality of negative electrode plates may be located a point adjacent to said spacing between each positive electrode plate. Further, the positive and negative plates may be alternately disposed to each other.

Another aspect of the present invention may have further include a pressing part of a predetermined width between each alternating positive and negative electrode plate sealing the first, second and third separators, and separating each alternating positive and negative electrode plate from each other.

Another aspect of the present invention may have the plurality of positive and negative electrode plates being folded at the guide part in a zigzag fashion to form a stack of the alternating positive and negative electrode plates.

Another aspect of the present invention may have the guide part further include a plurality of holes in at least one of the first, second and third separators.

Another aspect of the present invention may have the secondary battery further include a positive tab extending from each of the plurality of positive electrode plates. Further, a negative tab extending from each of the plurality of negative electrode plates.

Another aspect of the present invention may have the first to third separators be gel-phase coating layers.

Another exemplary embodiment of the present invention may be a method of assembling an electrode assembly. This method may include alternating placing a plurality of positive and negative electrode plates onto a first separator having a pressing part of a determined width between each of the plurality of positive and negative electrode plates. Still further, disposing a second separator disposed on an opposite side of the plurality of positive and negative electrode plates to that of the first separator and on each positive and negative electrode plate of the plurality of positive and negative electrode plates. Still further, sealing the first and second separator at the point of the pressing part and forming a guide part disposed in the first separator between the positive and negative electrode plates at about midpoint in a longitudinal direction of the width of the pressing part. Finally, folding the plurality of positive and negative electrode plates at the guide part in a zigzag fashion to form a stack of the alternating positive and negative electrode plates.

Another exemplary embodiment of the present invention may be a method of assembling an electrode assembly having a plurality of positive and negative electrode plates. This method may include placing the plurality of positive electrode plates onto a first separator with a space between adjacent positive electrode plates greater than the width of a single positive or negative electrode plate and a pressing part of a determined width. Still further, disposing a second separator disposed on a side of the plurality of positive electrode plates opposite to that of the first separator, said second separator comes in contact with said first separator in an area of the space and placing the plurality of negative electrode plates on the second separator on an opposite side from that of the plurality of positive electrode plates and with each negative electrode plate place at a point adjacent to said space between each positive electrode plate. Further, disposing a third separator on the plurality of negative electrode plates on an opposite side from that of the plurality of positive electrode plates and sealing the first, second and third separator at the point of the pressing part. Finally, forming a guide part disposed at about midpoint in a longitudinal direction of the width of the pressing part and folding the plurality of positive and negative electrode plates at the guide part in a zigzag fashion to form a stack of the alternating positive and negative electrode plates.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view illustrating an electrode assembly according to an embodiment;

FIG. 2A is a development plan view illustrating the electrode assembly according to the embodiment;

FIG. 2B is a sectional view of the electrode assembly taken along line I-I′ of FIG. 2A;

FIG. 2C is an enlarged view illustrating portion A of FIG. 2A;

FIG. 3 is a perspective view for explaining stacking of the electrode assembly illustrated in FIG. 2A;

FIG. 4 is a sectional view illustrating the electrode assembly after being stacked as shown in FIG. 3;

FIGS. 5A through 5D are views for explaining assembling processes of an electrode assembly according to the embodiment;

FIG. 6A is a development plan view illustrating an electrode assembly according to another embodiment;

FIG. 6B is a sectional view of the electrode assembly taken along line II-II′ of FIG. 6A;

FIGS. 7A through 7D are views for explaining assembling processes of an electrode assembly according to the other embodiment;

FIG. 8 is a perspective view illustrating a pouch type secondary battery according to an embodiment; and

FIG. 9 is a perspective view illustrating a can-type secondary battery according to an embodiment.

### DETAILED DESCRIPTION OF THE INVENTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the disclosure to those skilled in the art.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

Hereinafter, embodiments will be described in detail with reference to the accompanying drawings.

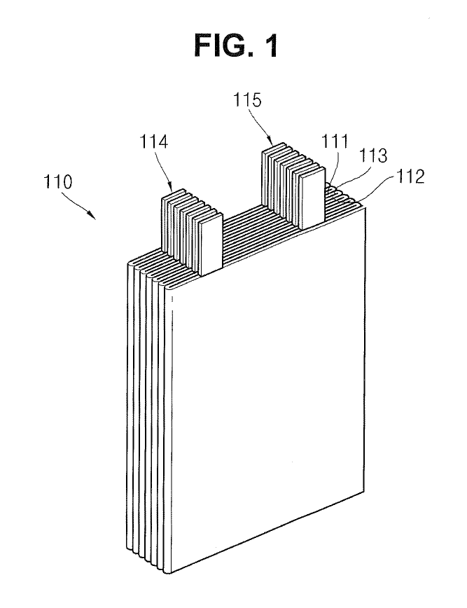

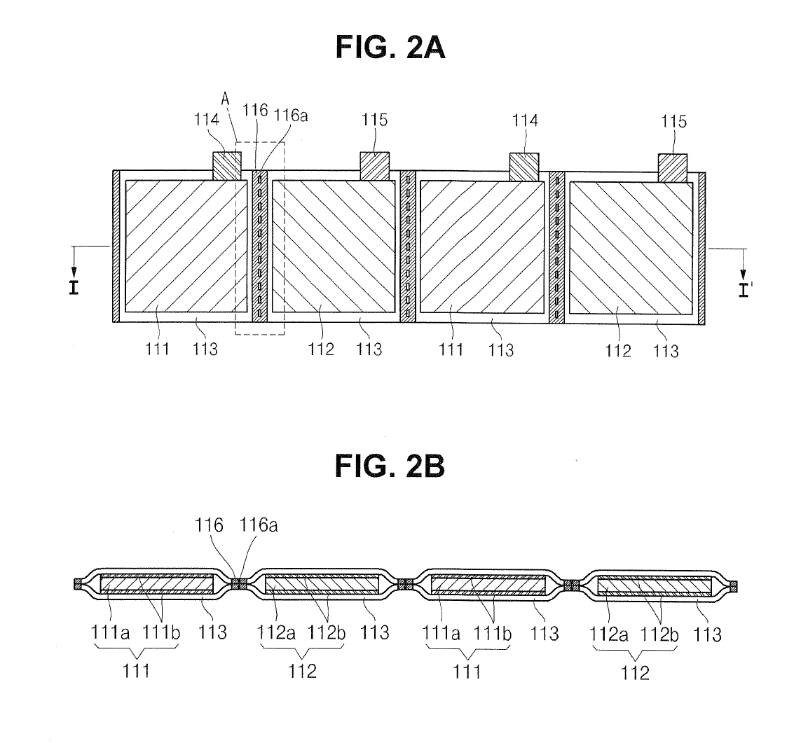

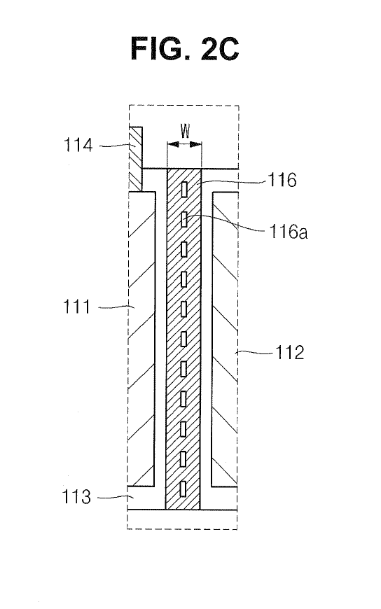

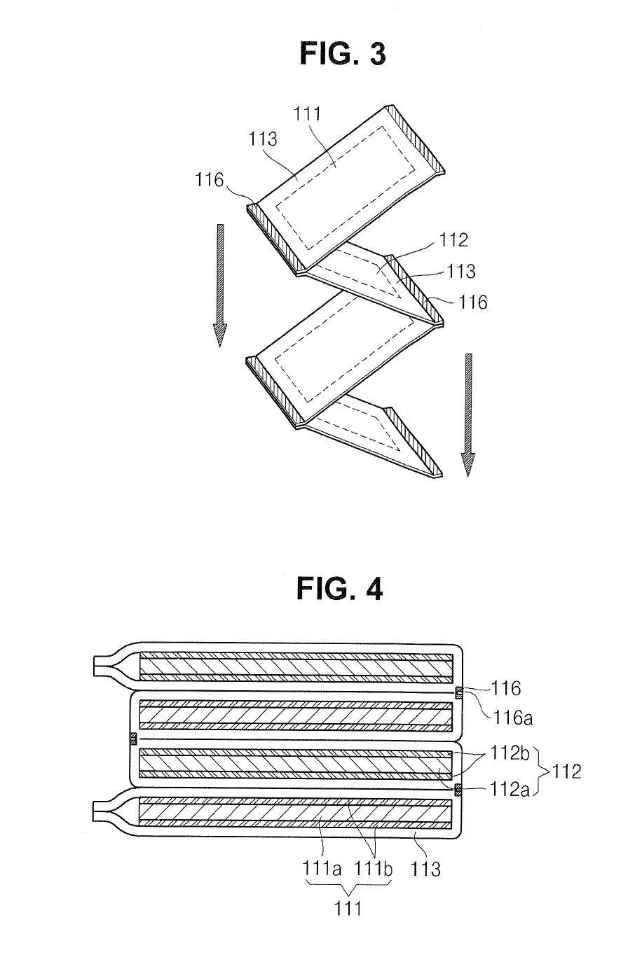

FIG. 1 is a perspective view illustrating an electrode assembly 110 according to an embodiment; FIG. 2A is a development plan view illustrating the electrode assembly 110 according to the embodiment; FIG. 2B is a sectional view of the electrode assembly 110 taken along line I-I′ of FIG. 2A; FIG. 2C is an enlarged view illustrating portion A of FIG. 2A; FIG. 3 is a perspective view for explaining stacking of the electrode assembly 110 illustrated in FIG. 2A; and FIG. 4 is a sectional view illustrating the electrode assembly 110 after the electrode assembly 110 is stacked as shown in FIG. 3.

Referring to FIGS. 1 through 4, the electrode assembly 110 of the current embodiment may include positive electrode plates 111, negative electrode plates 112, separators 113, positive electrode tabs 114, and negative electrode tabs 115. That is, the electrode assembly 110 has an accordion shape in which the positive electrode plates 111 and the negative electrode plates 112 may be stacked with the separators 113 being disposed therebetween.

Positive electrode coating portions 111b including, but not limited to, lithium oxide may be formed to a predetermined thickness on positive electrode collectors 111a formed of a thin metal film, so as to form the positive electrode plates 111. For example, the positive electrode plates 111 may be formed by coating aluminum foil or mesh (111a) with lithium cobalt oxide (such as LiCoO₂) (111b). However, the material of the positive electrode plates 111 is not limited thereto. Both sides of the positive electrode plates 111 may not be coated with the positive electrode coating portions 111b to form positive electrode non-coated portions. The positive electrode tabs 114 may be electrically connected to sides of the positive electrode non-coated portions and protrude upward from the electrode assembly 110.

Negative electrode coating portions 112b may be formed to a predetermined thickness on negative electrode collectors 112a formed of a thin metal film, so as to form the negative electrode plates 112. For example, the negative electrode plates 112 may be formed by attaching graphite (112b) to copper foil (112a). However, the material of the negative electrode plates 112 is not limited thereto. Both sides of the negative electrode plates 112 may be not coated with the negative electrode coating portions 112b including graphite to form negative electrode non-coated portions. The negative electrode tabs 115 are electrically connected to sides of the negative electrode non-coated portions and protrude upward from the electrode assembly 110. The negative electrode tabs 115 may include bending portions (not shown) as bending guides at predetermined positions so that the negative electrode tabs 115 can be bent at the predetermined positions. The bending portions may be formed into various shapes at positions where the negative electrode tabs 115 will be bent. Generally, since the negative electrode tabs 115 are formed of thin metal plates having a thickness of about 0.1 mm, the negative electrode tabs 115 are weak. Therefore, it may be necessary to determine the size of the bending portions according to the shape of the bending portions so as to minimize strength decreases of the negative electrode tabs 115 caused by the bending portions.

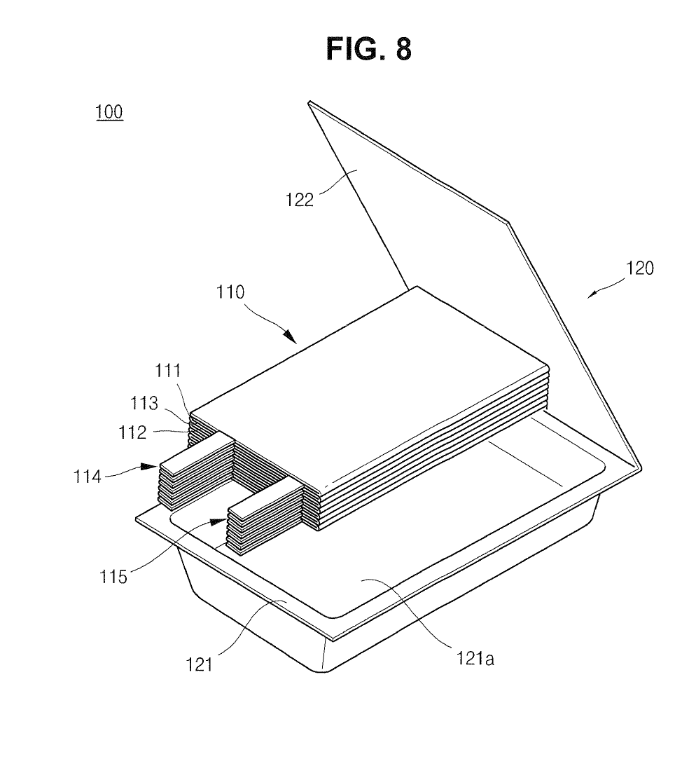

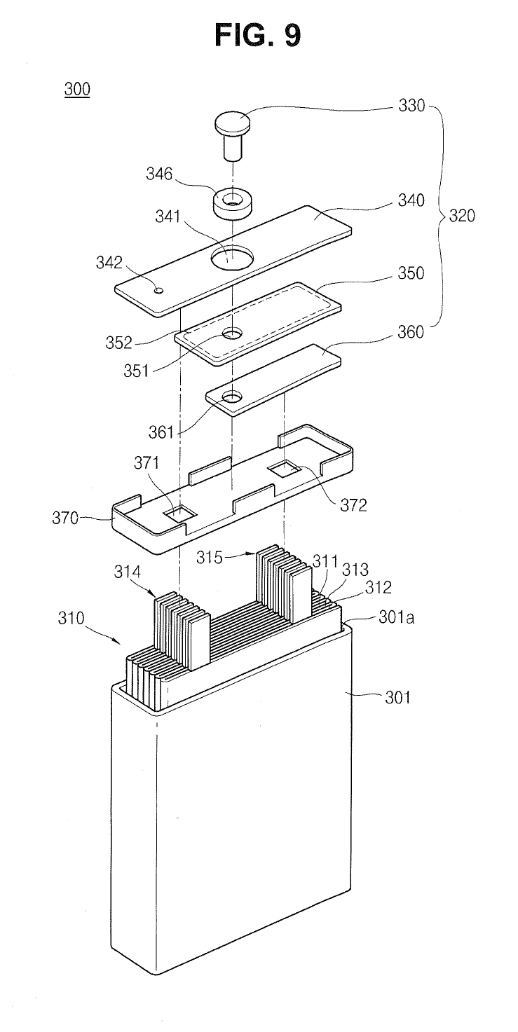

In the case of a pouch type lithium-ion secondary battery 100 shown in FIG. 8 (described later), the positive electrode tabs 114 and the negative electrode tabs 115 may be welded to connection leads so that the positive electrode tabs 114 and the negative electrode tabs 115 may be electrically connected to a protective circuit module. In the case of a can-type lithium-ion secondary battery 300 shown in FIG. 9 (described later), the positive electrode tabs 114 and the negative electrode tabs 115 may be electrically connected to a cap plate and a terminal plate of a cap assembly by welding.

The positive electrode plates 111 and the negative electrode plates 112 may be formed into the same shape and size. The negative electrode plates 112 and the negative electrode plates 112 may be arranged in turns in a state where the positive electrode plates 111 and the negative electrode plates 112 may be disposed between the separators 113 disposed at the front and rear sides of the positive electrode plates 111 and the negative electrode plates 112.

The separators 113 may be disposed at the front and rear sides of the positive electrode plates 111 and the negative electrode plates 112 to prevent a short circuit while allowing movement of lithium ions. The separators 113 may be made of polyethylene, poly propylene, or a composite film of polyethylene and poly propylene. However, the material of the separators 113 is not limited thereto.

Referring to FIGS. 2A through 2C, the separators 113 include pressing parts 116 between the positive electrode plates 111 and the negative electrode plates 112. The pressing parts 116 may be formed by pressing the separators 113 in a direction perpendicular to the top and bottom sides of the separators 113 by using hot pressing tools. The width (W) of the pressing parts 116 may be about 12 μm. Guide parts 116a may be formed at the pressing parts 116. The guide parts 116a may be constituted by a plurality of holes arranged at predetermined intervals. That is, the guide parts 116a may be constituted by a plurality of holes arranged in the form of a dashed line. When the positive electrode plates 111 and the negative electrode plates 112 are alternately stacked with the separators 113 being disposed therebetween, the positive electrode plates 111 and the negative electrode plates 112 can be aligned owing to the guide parts 116a.

That is, the electrode assembly 110 may be bent at the guide parts 116a of the pressing parts 116 to form a stacked structure in which the positive electrode plates 111 and the negative electrode plates 112 are disposed at the upper and lower sides of the separators 113. When the positive electrode plates 111 and the negative electrode plates 112 are stacked, the positive electrode tabs 114 of the positive electrode plates 111 and the negative electrode tabs 115 of the negative electrode plates 112 may be also stacked. That is, as many positive electrode tabs 114 as the number of the positive electrode plates 111 are stacked and electrically connected to each other by welding, and as many negative electrode tabs 115 as the number of negative electrode plates 112 are stacked and electrically connected to each other by welding.

Substantially, the electrode assembly 110 is accommodated in a case together with electrolyte. The electrolyte may include an organic solvent such as ethylene carbonate (EC), propylene carbonate (PC), diethyl carbonate (DEC), ethyl methyl carbonate (EMC), and dimethyl carbonate (DMC); and a lithium salt such as LiPF₆ or LiBF₄. The electrolyte may be liquid, solid, or gel. However, the electrolyte is not limited to the foregoing compounds or states of matter. When the electrode assembly 110 is accommodated in the case together with the electrolyte, the electrolyte may easily permeate the electrode assembly 110 through the guide parts 116a of the pressing parts 116.

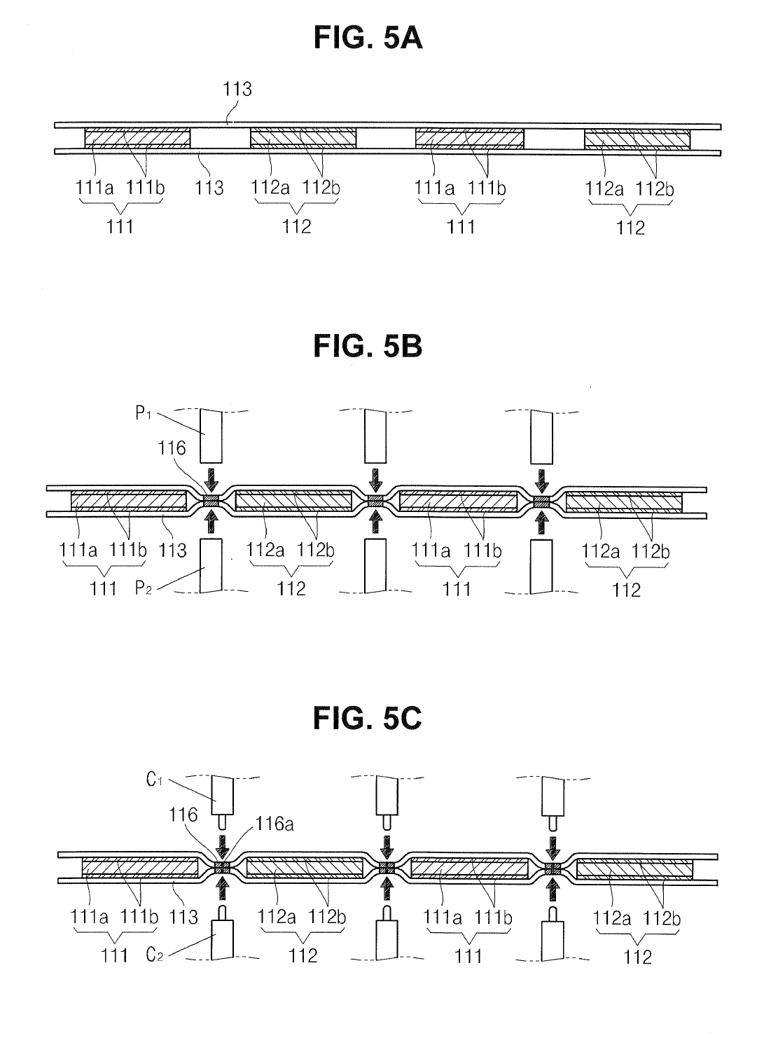

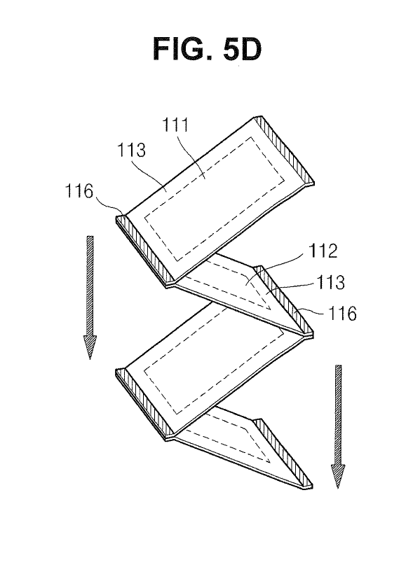

FIGS. 5A through 5D are sectional views for explaining assembling processes of an electrode assembly according to the embodiment.

Referring to FIG. 5A, positive electrode plates 111 and negative electrode plates 112 may be alternately arranged, and separators 113 are attached to the upper and lower sides of the positive electrode plates 111 and the negative electrode plates 112. That is, the positive electrode plates 111 and the negative electrode plates 112 may be alternately arranged at predetermined intervals between the separators 113.

Referring to FIG. 5B, hot pressing tools P1 and P2 are placed at the upper and lower sides of the separators 113 between the positive electrode plates 111 and the negative electrode plates 112, and parts of the separators 113 located between the positive electrode plates 111 and the negative electrode plates 112 are hot-pressed by using the hot pressing tools P1 and P2. That is, pressing parts 116 may be formed by thermally pressing a plurality of positions of the separators 113. The hot pressing tools P1 and P2 may be placed at the upper side, the lower side, or the upper and lower sides of the separators 113. That is, the current embodiment is not limited to the positions of the hot pressing tools P1 and P2.

Referring to FIG. 5C, hole forming tools C1 and C2 may be placed at the upper and lower sides of the pressing parts 116, and guide parts 116a may be formed by forming a plurality of holes through the pressing parts 116 by using the hole forming tools C1 and C2. In this way, a plurality of holes arranged in the form of a dashed line are formed as the guide parts 116a. The hole forming tools C1 and C2 may be placed at the upper side, the lower side, or the upper and lower sides of the pressing parts 116. That is, the current embodiment is not limited to the positions of the hole forming tools C1 and C2.

Referring to FIG. 5D, an electrode assembly 110 including the positive electrode plates 111, the negative electrode plates 112, and the separators 113 may be bent at the guide parts 116a so that the positive electrode plates 111 and the negative electrode plates 112 may be alternately stacked in a state where the separators 113 are disposed between the positive electrode plates 111 and the negative electrode plates 112. That is, the electrode assembly 110 is vertically or horizontally placed as shown in FIG. 5C and is vertically or horizontally compressed to bend the electrode assembly 110 at the plurality of holes of the guide parts 116a so that the positive electrode plates 111 and the negative electrode plates 112 can be alternately stacked.

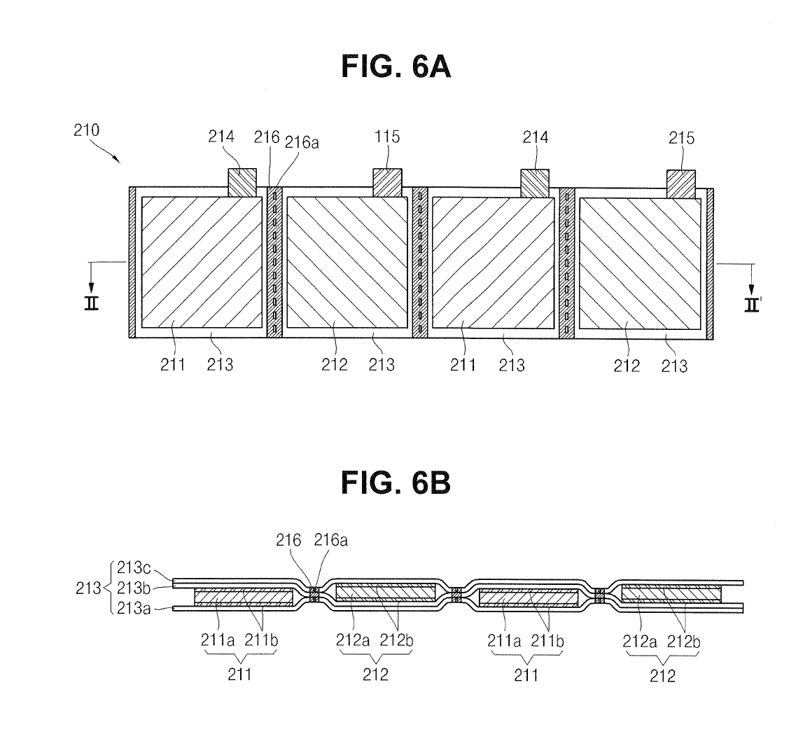

FIG. 6A is a development plan view illustrating an electrode assembly 210 according to another embodiment, and FIG. 6B is a sectional view of the electrode assembly 210 taken along line II-II′ of FIG. 6A,

Referring to FIGS. 6A and 6B, the electrode assembly 210 of the current embodiment includes positive electrode plates 211, negative electrode plates 212, separators 213, positive electrode tabs 214, and negative electrode tabs 215. The arrangement of the positive electrode plates 211, the negative electrode plates 212, and the separators 213 of the electrode assembly 210 of the current embodiment is different from the arrangement of the positive electrode plates 111, the negative electrode plates 112, and the separators 113 of the electrode assembly 110 of the previous embodiment. In the following description, the arrangement will be mainly explained.

The separators 213 may include a first separator 213a, a second separator 213b, and a third separator 213c. The first separator 213a and the third separator 213c may be formed of a solid polymer which can also function as electrolyte, or a gel polymer in which electrolyte is absorbed. The gel polymer may be polyethylene oxide (PEO), polyacrylonitrile (PAN), or polyvinylidne fluoride (PVDF), but not limited thereto. The electrolyte absorbed in the gel polymer may be a copolymer [P(VdF-co-HFP)] of polyvinylidne fluoride (PVDF) and polyhexafluoropropylene (PHFP), or a copolymer [P(VdF-co-CTFE)] of polyvinylidne fluoride (PVDF) and chlorotrifluoroethylene (CTFE). The second separator 213b may be made of polyethylene, poly propylene, or a composite film of polyethylene and poly propylene, but not limited thereto. The first separator 213a, the second separator 213b, and the third separator 213c of the separators 213 may be sequentially arranged from the lower side to the upper side.

The positive electrode plates 211 are arranged between the top surface of the first separator 213a and the bottom surface of the second separator 213b at intervals greater than the width of the positive electrode plates 211.

The negative electrode plates 212 may be arranged between the bottom surface of the third separator 213c and the top surface of the second separator 213b at intervals greater than the width of the negative electrode plates 212.

The separators 213 may include pressing parts 216 between the positive electrode plates 211 and the negative electrode plates 212. The pressing parts 216 may be formed by pressing the separators 213 in a direction perpendicular to the top and bottom sides of the separators 213 by using hot pressing tools. That is, the pressing parts 216 may be formed in a direction perpendicular to the top surface of the third separator 213c and the bottom surface of the first separator 213a by using the hot pressing tools. The width (W) of the pressing parts 216 may be about 12 μm. Guide parts 216a may be formed at the pressing parts 216. The guide parts 216a may be constituted by a plurality of holes arranged at predetermined intervals. That is, the guide parts 216a may be constituted by a plurality of holes arranged in the form of a dashed line. When the positive electrode plates 211 and the negative electrode plates 212 are alternately stacked with the separators 213 being disposed therebetween, the positive electrode plates 211 and the negative electrode plates 212 can be aligned owing to the guide parts 216a.

The electrode assembly 210 may be bent at the guide parts 216a in a zigzag shape so that the positive electrode plates 211 and the negative electrode plates 212 can be alternately stacked.

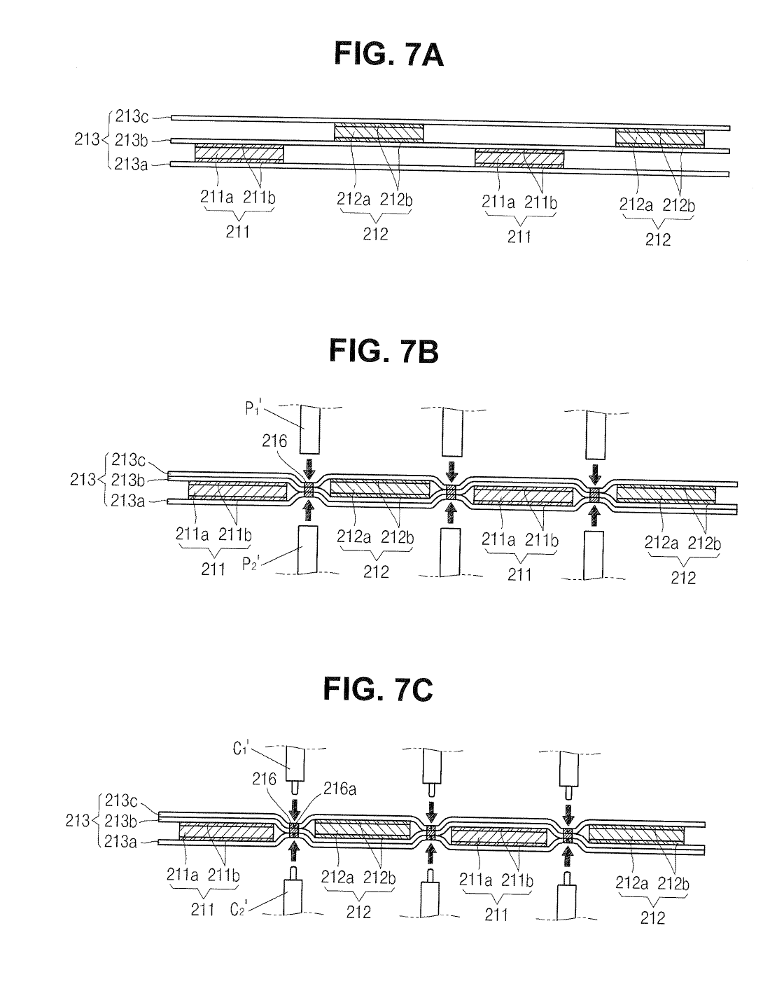

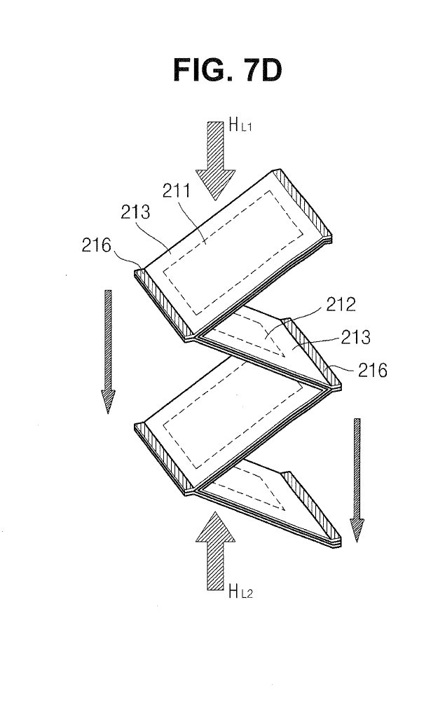

FIGS. 7A through 7D are views for explaining assembling processes of an electrode assembly according to the other embodiment.

Referring to FIG. 7A, a plurality of positive electrode plates 211 may be disposed between the top surface of a first separator 213a and the bottom surface of a second separator 213b at intervals greater than the width of the positive electrode plates 211. Then, a plurality of negative electrode plates 212 may be arranged between the bottom surface of a third separator 213c and the top surface of the second separator 213b at intervals greater than the width of the negative electrode plates 212. The first separator 213a, the second separator 213b, and the third separator 213c may be formed on the top and bottom surfaces of the positive electrode plates 211 and the negative electrode plates 212 through a heat laminating process.

Referring to FIG. 7B, hot pressing tools P1 and P2 are placed respectively at the upper side of the third separator 213c and the lower side of the first separator 213a between the positive electrode plates 211 and the negative electrode plates 212, and parts of the separators 213 located between the positive electrode plates 211 and the negative electrode plates 212 may be hot-pressed by using the hot pressing tools P1 and P2. That is, pressing parts 216 may be formed by hot-pressing a plurality of positions of the separators 213. The hot pressing tools P1 and P2 may be placed at the upper side of the third separator 213c, the lower side of the first separator 213a, or the upper side of the third separator 213c and the lower side of the first separator 213a. That is, the current embodiment is not limited to the positions of the hot pressing tools P1 and P2.

Referring to FIG. 7C, hole forming tools C1 and C2 may be placed at the upper and lower sides of the pressing parts 216, and guide parts 216a are formed by forming a plurality of holes through the pressing parts 216 by using the hole forming tools C1 and C2. In this way, a plurality of holes arranged in the form of a dashed line may be formed as the guide parts 216a. The hole forming tools C1 and C2 may be placed at the upper side, the lower side, or the upper and lower sides of the pressing parts 216. That is, the current embodiment is not limited to the positions of the hole forming tools C1 and C2.

Referring to FIG. 7D, an electrode assembly 210 including the positive electrode plates 211, the negative electrode plates 212, and the separators 213 may be bent at the guide parts 216a so that the positive electrode plates 211 and the negative electrode plates 212 can be alternately stacked in a state where the separators 213 are disposed between the positive electrode plates 211 and the negative electrode plates 212. That is, the electrode assembly 210 is vertically or horizontally placed as shown in FIG. 7C and is compressed in vertical directions (H_{L1}, H_{L2}) or horizontal directions to bend the electrode assembly 210 at the plurality of holes of the guide parts 216a so that the positive electrode plates 211 and the negative electrode plates 212 can be alternately stacked.

FIG. 8 is a perspective view illustrating a pouch type secondary battery 100 according to an embodiment.

Referring to FIG. 8, the pouch type secondary battery 100 may include a pouch 120. The pouch 120 may include a lower pouch 121 and an upper pouch 122. The lower pouch 121 may further include a recess 121a to accommodate an electrode assembly 110. The recess 121a may be formed by a pressing process. A groove (not shown) may be formed at a side of the recess 121a, for example, to release gas generated when the secondary battery 100 is fabricated.

The electrode assembly 110 may be any one of the electrode assemblies described with reference to FIGS. 1 through 7D.

When the electrode assembly 110 is formed, positive electrode tabs 114 and negative electrode tabs 115 may be attached to edge-side non-coated portions of positive electrode plates 111 and negative electrode plates 112 by a method such as ultrasonic welding.

Separators 113 may be made of polyethylene, poly propylene, or a composite film of polyethylene and poly propylene, but not limited thereto. In this case, owing guide parts formed in the separators 113, the electrolyte may easily permeate into the electrode assembly 110. The separators 113 are wider than the positive electrode plates 111 and the negative electrode plates 112 to prevent a short circuit between the positive electrode plates 111 and the negative electrode plates 112.

A member such as a resin film or tape may be attached to overlapping parts between the positive and negative electrode tabs 114 and 115 and the electrode assembly 110, and parts of the positive and negative electrode tabs 114 and 115 welded to the pouch 120 (that is, overlapping parts between the positive and negative electrode tabs 114 and 115 and a flange part of the pouch 120). The member may be formed of a thermally adhesive material that adheres more strongly to the positive and negative electrode tabs 114 and 115 made of metal than to the inside of the pouch 120.

FIG. 9 is a perspective view illustrating a can-type secondary battery 300 according to an embodiment.

Referring to FIG. 9, the can-type secondary battery 300 of the current embodiment includes a can 301, an electrode assembly 310 accommodated in the can 301, and a cap assembly 320 configured to seal a top opening 301 a of the can 301.

The can 301 may be made of a metal material and has a box shape. The can 301 may include the top opening 301a to receive the electrode assembly 310 through the top opening 301a.

The electrode assembly 310 may be any one of the electrode assemblies described with reference to FIGS. 1 through 7D.

Positive electrode tabs 314 may be welded to positive electrode plates 311, and ends of the positive electrode tabs 314 protrude upward from the electrode assembly 310. Negative electrode tabs 315 may be welded to negative electrode plates 312, and ends of the negative electrode tabs 315 protrude upward from the electrode assembly 310.

Separators 313 may be made of polyethylene, poly propylene, or a composite film of polyethylene and poly propylene, but not limited thereto. In this case, owing guide parts formed in the separators 113, the electrolyte may easily permeate into the electrode assembly 310. The separators 313 are wider than the positive electrode plates 311 and the negative electrode plates 312 to prevent a short circuit between the positive electrode plates 311 and the negative electrode plates 312.

The cap assembly 320 includes a cap plate 340, an insulation plate 350, a terminal plate 360, and an electrode terminal 330. The cap assembly 320 is coupled to the top opening 301a of the can 301 to seal the can 301.

The positive electrode tabs 314 may be electrically connected to the cap plate 340 by welding, and the negative electrode tabs 315 are electrically connected to the terminal plate 360 by welding.

In the electrode assembly 310, the positive electrode plates 311 and the negative electrode plates 312, and the positive electrode tabs 314 and the negative electrode tabs 315 may be disposed in opposite positions according to the type of the can-type secondary battery 300.

The cap plate 340 may be formed of a metal plate having a size and shape corresponding to the top opening 301a of the can 301. A first terminal hole 341 having a predetermined size is formed through the center of the cap plate 340, and an electrolyte injection hole 342 is formed at a side of the first terminal hole 341. The electrode terminal 330 is inserted through the first terminal hole 341 in a state where a gasket tube 346 is fitted to the first terminal hole 341 so as to insulate the electrode terminal 330 from the cap plate 340.

After the cap assembly 320 is assembled to the top opening 301a of the can 301, electrolyte may be injected through the electrolyte injection hole 342, and the electrolyte injection hole 342 is closed by using a sealing member.

The insulation plate 350 may be formed of an insulation material like the gasket tube 346. A rest recess 352 may be formed in the bottom surface of the insulation plate 350 to receive the terminal plate 360. A second terminal hole 351 may be formed through the insulation plate 350 at a position corresponding to the first terminal hole 341 so as to receive the electrode terminal 330.

The terminal plate 360 may be coupled to the rest recess 352 of the insulation plate 350. A third terminal hole 361 may be formed through the terminal plate 360 at a position corresponding to the first terminal hole 341 so as to receive the electrode terminal 330.

The electrode terminal 330 may be inserted through the first terminal hole 341, the second terminal hole 351, and the third terminal hole 361 in a state where the electrode terminal 330 is insulated by the gasket tube 346, and then the electrode terminal 330 is coupled to the terminal plate 360. That is, in the cap assembly 320, the terminal plate 360 may be electrically connected to the electrode terminal 330 but is electrically insulated from the cap plate 340.

An insulation case 370 may include a positive electrode tab hole 371 and a negative electrode tab hole 372. The insulation case 370 may be coupled to the bottom side of the cap assembly 320 to electrically insulate the cap assembly 320 and the electrode assembly 310. The positive electrode tabs 314 may be inserted through the positive electrode tab hole 371 and are welded to the cap plate 340. The negative electrode tabs 315 may be inserted through the negative electrode tab hole 372 and are welded to the cap plate 360. For this, the positive electrode tab hole 371 and the negative electrode tab hole 372 may be sized in a manner such that the lower ends of the positive electrode tabs 314 and the negative electrode tabs 315 can be inserted through the positive electrode tab hole 371 and the negative electrode tab hole 372.

Therefore, according to the electrode assembly and the secondary battery including the electrode assembly of the embodiments, owing to the pressing parts formed on the separators surrounding positive and negative electrodes, the electrode assembly may be bent in a zigzag shape to form a stacked structure. Therefore, it is unnecessary to stack the positive and negative electrodes in a condition that the positive and negative electrodes have the same size. In addition, the thermal stability of the electrode assembly can be improved, and the stacked structure of the electrode assembly can be easily formed.

In addition, according to the electrode assembly and the secondary battery including electrode assembly of the embodiments, owing to the guide parts formed at the pressing parts of the separators, electrolyte can easily permeate the electrode assembly.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure as set forth in the following claims.

What is claimed is:

1. A secondary battery having an electrode assembly, the electrode assembly comprising:
a plurality of positive and negative electrode plates; and
a first separator in which each positive and negative electrode plate of the plurality of positive and negative electrode plates are disposed on the first separator in a side-by-side manner with alternating positive and negative electrode plates and the first separator is folded at a guide part in a zigzag fashion,
wherein the guide part is disposed in the first separator and between the positive and negative electrode plates.

2. The secondary battery recited in claim 1, further comprising:
a pressing part of a predetermined width between each alternating positive and negative electrode plate sealing the first separator, and separating each alternating positive and negative electrode plate from each other.

3. The secondary battery recited in claim 2, further comprising:
a second separator disposed on an opposite side of the plurality of positive and negative electrode plates to that of the first separator and on each positive and negative electrode plate of the plurality of positive and negative electrode plates.

4. The secondary battery recited in claim 3, wherein the guide part comprises a plurality of holes though at least one of the first and second separator.

5. The secondary battery recited in claim 3, wherein the guide part is formed in the pressing part.

6. The secondary battery recited in claim 1, further comprising:
a positive tab extending from each of the plurality of positive electrode plates; and
a negative tab extending from each of the plurality of negative electrode plates.

7. The secondary battery recited in claim 1, further comprising:
a pouch to hold the electrode assembly and electrolyte.

8. The secondary battery recited in claim 1, comprising:
a second and third separators, the plurality of positive electrode plates is disposed on the first separator, said second separator is disposed on a side of the plurality of positive electrode plates opposite to that of the first separator;
a plurality of negative electrode plates disposed on the second separator on an opposite side from that of the plurality of positive electrode plates and, and said third separator disposed on the plurality of negative electrode plates on an opposite side from that of the plurality of positive electrode plates.

9. The secondary battery recited in claim 8, comprising:
a guide part is disposed through at least one of the first, second and third separator between the positive and negative electrode plates.

10. The secondary battery recited in claim 8, comprising:
a spacing between each positive electrode plate greater than a width of a single positive or negative electrode plate, the plurality of negative electrode plates are located a point adjacent to said spacing between each positive electrode plate,
wherein the positive and negative plates are alternately disposed to each other.

11. The secondary battery recited in claim 10, comprising:
a pressing part of a predetermined width between each alternating positive and negative electrode plate sealing the first, second and third separators, and separating each alternating positive and negative electrode plate from each other.

12. The secondary battery recited in claim 11, wherein said plurality of positive and negative electrode plates are folded at the guide part in a zigzag fashion to form a stack of the alternating positive and negative electrode plates.

13. The secondary battery recited in claim 12, wherein the guide part comprises a plurality of holes in at least one of the first, second and third separators.

14. The secondary battery recited in claim 13, further comprising:
a positive tab extending from each of the plurality of positive electrode plates; and
a negative tab extending from each of the plurality of negative electrode plates.

15. The secondary battery recited in claim 13, wherein the first to third separators are gel-phase coating layers.

16. A method of assembling an electrode assembly, comprising:
alternating placing a plurality of positive and negative electrode plates onto a first separator having a pressing part of a determined width between each of the plurality of positive and negative electrode plates;
disposing a second separator disposed on an opposite side of the plurality of positive and negative electrode plates to that of the first separator and on each positive and negative electrode plate of the plurality of positive and negative electrode plates
sealing the first and second separator at the point of the pressing part;
forming a guide part disposed in the first separator between the positive and negative electrode plates at about midpoint in a longitudinal direction of the width of the pressing part; and
folding the plurality of positive and negative electrode plates at the guide part in a zigzag fashion to form a stack of the alternating positive and negative electrode plates.

17. A method of assembling an electrode assembly having a plurality of positive and negative electrode plates, comprising:
placing the plurality of positive electrode plates onto a first separator with a space between adjacent positive electrode plates greater than the width of a single positive or negative electrode plate and a pressing part of a determined width;
disposing a second separator disposed on a side of the plurality of positive electrode plates opposite to that of the first separator, said second separator comes in contact with said first separator in an area of the space;
placing the plurality of negative electrode plates on the second separator on an opposite side from that of the plurality of positive electrode plates and with each negative electrode plate place at a point adjacent to said space between each positive electrode plate;
disposing a third separator on the plurality of negative electrode plates on an opposite side from that of the plurality of positive electrode plates;
sealing the first, second and third separator at the point of the pressing part;
forming a guide part disposed at about midpoint in a longitudinal direction of the width of the pressing part; and
folding the plurality of positive and negative electrode plates at the guide part in a zigzag fashion to form a stack of the alternating positive and negative electrode plates.
